(19) United States
(12) Patent Application Publication
(10) Pub. No.: US 2018/0054626 A1
(43) Pub. Date: Feb. 22, 2018

(54) DECODING METHOD AND DECODING APPARATUS FOR AVS SYSTEM

(71) Applicant: MStar Semiconductor, Inc., Hsinchu Hsien (TW)

(72) Inventors: He-Yuan Lin, Zhubei City (TW); Yi-Shin Tung, Zhubei City (TW)

(21) Appl. No.: 15/459,213

(22) Filed: Mar. 15, 2017

(30) Foreign Application Priority Data
Aug. 17, 2016 (TW) 105126229

(51) Int. Cl. H04N 19/42; H04N 19/98; H04N 19/85

(52) U.S. Cl. CPC H04N 19/42; H04N 19/85; H04N 19/98

(57) ABSTRACT

A method for decoding audio/video data in an Audio Video coding Standard (AVS) system is provided. A predetermined upper limit of an offset shift, greater than zero and smaller than an upper limit of a range shift, is provided. Whether to terminate an offset pre-fetching process is determined according to whether an offset shift reaches the upper limit of the offset shift. After offset shift pre-fetching process is terminated, a most significant bit (MSB) of a valid offset is preserved. The preserved valid MSB of the valid offset is used as a reference when a symbol to be decoded is determined to be a most probable symbol or a least probable symbol.

This application claims the benefit of Taiwan application Serial No. 105126229, filed Aug. 17, 2016, the subject matter of which is incorporated herein by reference.

### BACKGROUND OF THE INVENTION

### Field of the Invention

The invention relates in general to a multimedia signal processing technology, and more particularly to a decompression technology in the Audio Video coding Standard (AVS).

### Description of the Related Art

Digital television broadcasting has matured and become popular with the ever-improving communication technologies. In addition to being transmitted through cables, digital television signals may be propagated in form of wireless signals via base stations or artificial satellites. To satisfy demands on enhanced image quality and reduced transmission data amount, a transmitter usually encodes and decompresses audio/video signals to be transmitted. Correspondingly, a receiver needs to correctly decode and decompress the received signals in order to restore the audio/video signals.

The Audio Video coding Standard (AVS) commonly used in China adopts Advanced Entropy Coding (AES) to process audio/video data. Associated implementation details may be referred from the U.S. Pat. No. 7,808,406, and documentations provided by the AVS work team. Generally known to one person skilled in the art, binary arithmetic coding performed by a binary arithmetic coding engine of an AVS receiver is an iteration process, whose input is referred to as an offset. By finding a relationship between relative sizes of the offset and a range, a current symbol to be decoded may be determined as a most probable symbol (MPS) or a least probable symbol (LPS). There are only two possibilities for a symbol to be decoded in the binary arithmetic coding—1 and 0. Between these two possibilities, the one having a probability of occurrence greater than 0.5 is an MPS, and the other is an LPS.

Two main variables associated with the range are a range shift and a valid range, and two main variables associated with the offset are an offset shift and a valid offset. In practice, a data length that the binary arithmetic coding engine can process each time is limited. Defined in the current AVS technical documents, the binary arithmetic coding engine sets the lengths of the range shift and the effect range as binary 8-bit values, respectively. On the other hand, the lengths of the offset shift and the valid offset are set as a binary 32-bit value and a binary 9-bit value, respectively.

The arithmetic coding engine at the AVS receiver first performs a conventional offset initialization process, which is depicted in FIG. 1. In step S101, the offset shift is set to 0. In step S120, 9-bit audio/video data is fetched as the valid offset. Step S103 and step S104 represent an offset pre-fetching process. In step S103, it is determined “whether the valid offset is smaller than 256”. A valid offset smaller than 256 means that a most significant bit (MSB) (the 9^{th} bit) of the valid offset is binary. When the determination of step S103 is affirmative, step S104 is performed, to shift the valid offset to the left by one bit and a next bit is then fetched. Correspondingly, the offset shift is incremented by 1. Step S103 is iterated. When the determination result of step S103 is negative, the offset pre-fetching process represented by steps S103 and S104 is terminated. In step S105, the last 8 bits of the valid offset are retrieved as the new valid offset. The offset shift determined in step S104 and the valid offset determined in step S105 jointly form an initial offset adopted in the subsequent decoding process.

A main decoding process performed by an arithmetic coding engine of a conventional AVS receiver is as shown in FIG. 2(A) and FIG. 2(B). The function of step S201 is to fetch a latest updated context model of a previous decoding process, so as to accordingly learn whether an MPS in the current decoding process is binary 0 or binary 1 and to learn the probability of the MPS. The function of step S202 is updating the range shift and the valid range according to the older range and the probability of the MPS, and determining whether the content of a determination flag is binary 0 or binary 1. An associated detail process is depicted as sub-steps S202A to S202G in FIG. 3.

Step S203 is a main determination step of the entire decoding process, i.e., determining whether the current symbol to be decoded is an MPS or an LPS. Step S203 may be divided to include three determinations below: 1) whether the range shift is greater than the offset shift; 2) whether the range shift is equal to the offset shift; and 3) whether the valid shift is greater than or equal to the valid range. When the determination result of the determination (1) is affirmative, or the determination results of both the determination (2) and the determination (3) are affirmative, step S204 of determining the symbol to be decoded as an LPS is performed. Conversely, when the determination result of the determination (1) is negative, and any of the determination results of the determination (2) and the determination (3) is negative, step S291 of determining the symbol to be decoded as an MPS is performed.

Steps S205 to S213 after step S204 are a series of parameter updating processes that are only performed when the symbol to be decoded is determined as an LPS. More specifically, steps S205 to S207 determine how to update an LPS range according to the status of the flag. Steps S208 to S210 determine how to update the valid offset according to the relationship between the range shift and the offset shift. Steps S211 to S213 determine how to update the valid offset and the valid range according to the LPS range.

The main function of steps S214 to S218 is to pre-fetch a subsequent offset for the use of a next symbol determination process. Step S214 resets the range shift to zero. S215 resets the offset shift to zero. Steps S216 to S218 are identical to steps S103 to S105 in FIG. 1, i.e., selectively fetching a subsequent bit from the audio/video data as the valid offset, and setting the offset shift according to the number of bits actually fetched. Step S219 updates the context model and returns a decoding result. As shown in FIG. 2(A), after the symbol to be decoded is determined as an MPS in step S291, step S292 similarly updates the context model and returns a decoding result.

In the above decoding process, steps associated with pre-fetching the subsequent offset are flawed, with reasons explained below.

In step S203 in FIG. 2(A), the offset shift and the range shift are compared. As previously stated, the length of the offset shift is 32 bits, and the length of the range shift is 8 bits. Thus, the offset shift may be 2³²-1 at most, whereas the range shift may be only 2⁸-1 at most (i.e., 255). In practice, when the offset shift is smaller than or equal to 254, the range shift may gradually catch up with the above offset shift through step S202E, such that the comparison basis of the valid offset and the valid range are kept consistent.

It is known that binary 0 may successively occur for more than 245 times in the audio/video data that an arithmetic coding engine at a receiver receives. Thus, the pre-fetching steps S216 and S217 are performed for more than 254 times, in a way that the offset shift is added up to be greater than 254. However, in the above decoding process, only when the determination result of step S203 is affirmative (i.e., determining the symbol to be decoded as an LPS), the step of resetting the offset shift to zero (step S215) is then performed. In practice, once the offset shift is added up to be greater than 254, the determination result of step S203 becomes persistently zero, which leads to a total breakdown of the process and outputs an incorrect decoding result.

The same situation may occur in the offset initialization process in FIG. 1. Comparing FIG. 1 and FIG. 2(B), it is seen that the pre-fetching steps S103 to S105 are identical to the pre-fetching steps S216 to S218. That is to say, it is possible that the offset shift be already added up to be greater than 254 to cause the above issue of a decoding process breakdown.

### SUMMARY OF THE INVENTION

The invention is directed to a decoding method and a decoding apparatus for a Audio Video coding Standard (AVS) system. By appropriate setting a stop fetching flag for an offset fetching process, the decoding method and the decoding apparatus of the present invention are capable of validly preventing an offset shift from becoming greater than an upper limit of a range shift, so as to prevent a decoding process breakdown. When the decoding method and the decoding apparatus of the present invention are adopted, no associated preventive measures (e.g., causing binary 0 not to successively appear for more than 254 times in audio/video data) need to be performed on an encoded result outputted from an AVS encoding end, nor the size of a register used for storing a range offset in an AVS decoding end needs to be modified.

According to an embodiment of the present invention, a decoding method for decoding audio/video data in an AVS system is provided. According to the decoding method, an upper limit of an offset shift greater than zero and smaller than an upper limit of a range shift is provided. Whether to terminate an offset pre-fetching process is determined according to whether an offset shift reaches the upper limit of the offset shift. After the offset shift pre-fetching process is terminated, a most significant bit (MSB) of a valid offset is preserved. The preserved valid offset is used as a reference for determining whether a symbol to be decoded is one of a most probable symbol (MPS) and a least probable symbol (LPS) in a next symbol determination process.

According to another embodiment of the present invention, a decoding apparatus for decoding audio/video data in an AVS system is provided. The decoding apparatus includes an offset pre-fetching circuit and a symbol determining circuit. An upper limit of an offset shift greater than zero and smaller than an upper limit of a range shift is provided. The offset pre-fetching circuit performs an offset pre-fetching process, determines whether to terminate the offset pre-fetching process according to whether an offset shift reaches the upper limit of the offset shift, and preserves a most significant bit (MSB) of a valid offset after the offset shift pre-fetching process is terminated. The symbol determining circuit performs a next symbol determination process according to the preserved MSB of the valid offset to determine whether a symbol is one of an MPS and an LPS.

According to another embodiment of the present invention, a decoding method for decoding audio/video data in an AVS system is provided. According to the decoding method, an offset pre-fetching process includes: a) determining whether a valid offset is lower than a predetermined value; b) fetching a new least significant bit (LSB) for the valid offset when the determination result of step (a) is affirmative; and c) terminating the offset pre-fetching process after step (b) is performed once.

According to another embodiment of the present invention, a decoding apparatus for decoding audio/video data in an AVS system is provided. The decoding apparatus includes an offset pre-fetching circuit that performs a pre-fetching process. The offset pre-fetching circuit includes a determining circuit and a fetching circuit. The determining circuit determines whether a valid offset is smaller than a predetermined value. When the determination result of the determining circuit is affirmative, the fetching circuit fetches a new LSB for the valid offset and then terminates the offset pre-fetching process.

According to another embodiment of the present invention, a decoding method for decoding audio/video data in an AVS system is provided. The decoding method includes determining whether the audio/video data includes at least one set of bypass data. When the determination result is negative, a first decoding process is performed on the audio/video data. When the determination result is affirmative, a second decoding process different from the first decoding process is performed on the at least one set of bypass data.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a flowchart of an offset initialization process adopted by a conventional AVS receiver;

FIG. 2(A) (prior art) and FIG. 2(B) (prior art) are flowcharts of a main decoding process that an arithmetic coding engine adopts at a conventional AVS receiver;

FIG. 3 (prior art) shows detailed sub-steps and process of step S202 in FIG. 2;

FIG. 4 is a flowchart of an offset initialization process according to an embodiment of the present invention;

FIG. 5(A) and FIG. 5(B) are flowcharts of a main decoding process according to an embodiment of the present invention;

FIG. 6 is a functional block diagram of a decoding apparatus according to an embodiment of the present invention;

FIG. 7 is a flowchart of an offset initialization process according to another embodiment of the present invention;

FIG. 8 is a partial flowchart of an offset initialization process according to another embodiment of the present invention;

FIG. 9 is a flowchart of a decoding method according to another embodiment of the present invention;

FIG. 10 is a flowchart of a second decoding process according to an embodiment of the present invention;

FIG. 11 is a flowchart of a second decoding process according to another embodiment of the present invention; and

FIG. 12 is a functional block diagram of a decoding apparatus according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

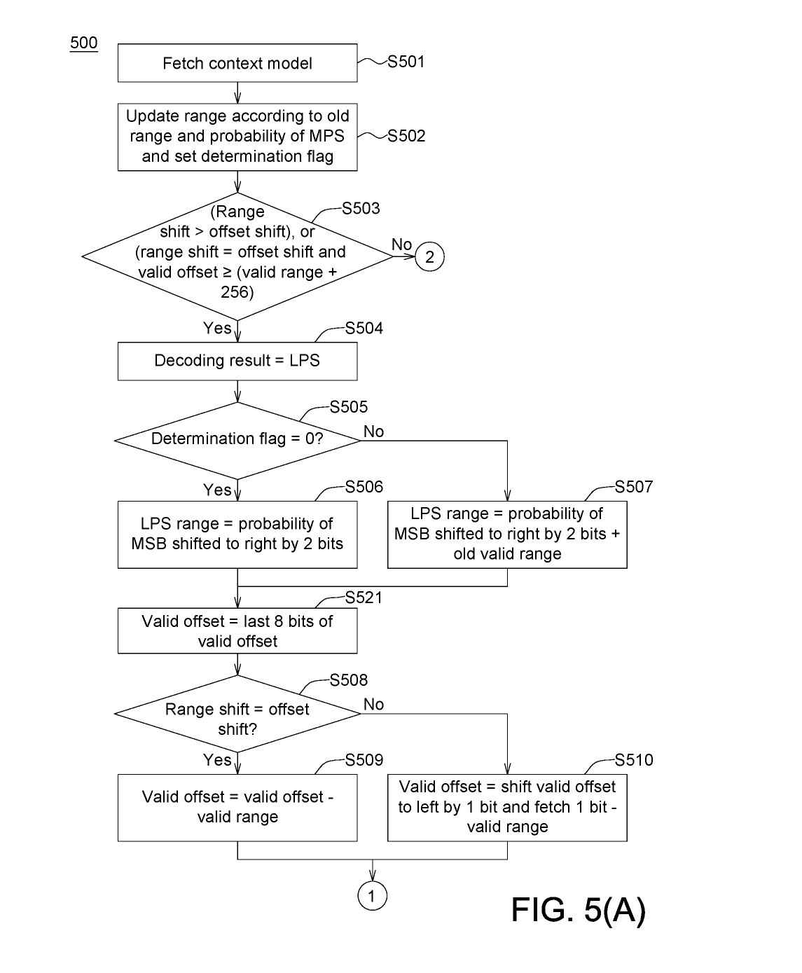

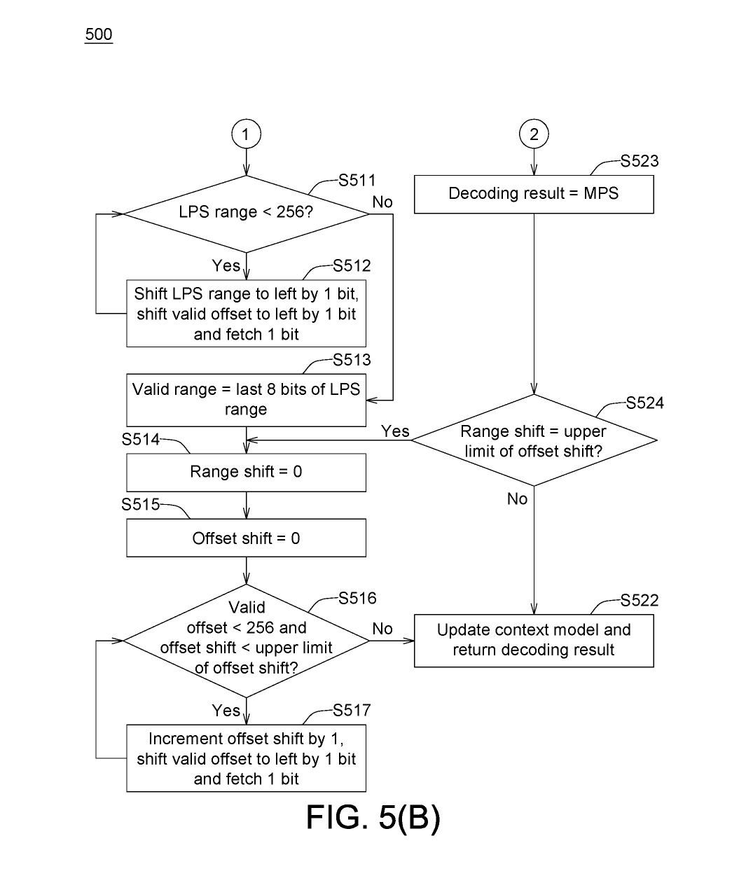

A decoding method for decoding audio/video data in an Audio Video coding Standard (AVS) system is provided according to an embodiment of the present invention. FIG. 4, FIG. 5(A) and FIG. 5(B) show flowcharts of the decoding method. In the description below, it is assumed that lengths of four variables, including a range shift, a valid range, an offset shift and a valid offset, are set to binary 8-bit, 8-bit, 32-bit and 9-bit values, respectively. Through the description below, one person skilled in the art can understand that, the concept of the present invention may be applied to a situation where the variable lengths are different from the above assumption.

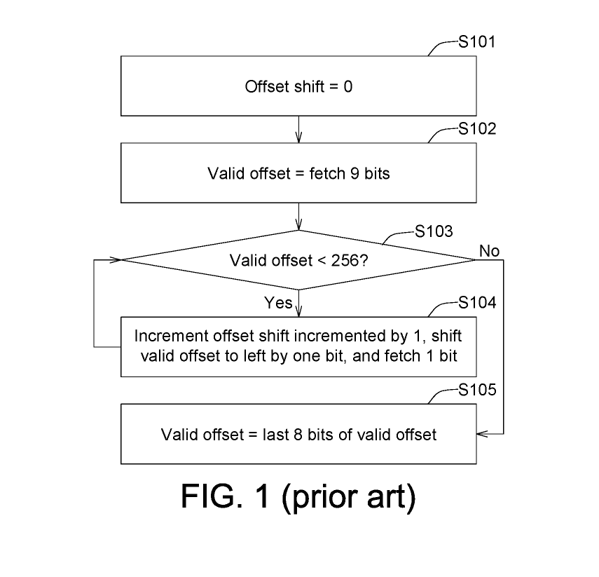

FIG. 4 shows an offset initialization process 400. Comparing FIG. 1 and FIG. 4, it is seen that steps S401 and S402 are identical to steps S101 and S102. Different from step S103, in addition to determining whether “the valid offset is smaller than 256”, step S403 further determines whether “the offset shift is smaller than an upper limit N of the offset shift”. The upper limit N of the offset shift is greater than zero and smaller than an upper limit of the range shift. When the length of the range shift is 8-bit, the upper limit of the range shift is equal to 255, and the upper limit N of the offset shift may then be any positive integer between 1 and 254. When the determination result of step S403 is negative, the offset initialization process 400 is terminated. When the determination result of step S403 is affirmative, step S404 is performed, where the valid offset is shifted to the left by one bit and a next bit is fetched. Correspondingly, the offset shift is incremented by 1. Step S403 is then iterated.

It should be noted that, the step of resetting the most significant bit (MSB) of the valid offset to binary 0 (step S105) does not appear in the offset initialization process 400. More specifically, after the offset pre-fetching process is terminated, the MSB (the 9^{th} bit) of the valid offset is intentionally preserved to record a reason of terminating the offset pre-fetching process. More specifically, when the determination result of step S403 (whether “the valid offset is smaller than 256” and “the offset shift is smaller than the upper limit N of the offset shift”) is negative due to “the valid offset is greater than or equal to 256”, the MSB of the current valid offset is naturally binary 1. Similarly, the determination result of step S403 is negative because the two conditions “the valid offset is greater than or equal to 256” and “the offset shift is greater than or equal to the upper limit N of the offset shift” are simultaneously true, the MSB of the current valid offset must be binary 1. In contrast, when the determination result of step S403 is negative because the condition “the offset shift reaches the upper limit N of the offset shift” is true, and the condition “the valid offset is greater than or equal to 256” is false, the MSB of the valid offset is naturally binary 0.

Taking an instance where a valid offset fetched in step S402 is “000000001” and the upper limit N of the offset shift is equal to 4, steps S403 and S404 are iterated four times. Only when the accumulated value of the offset shift is no longer smaller than 4, the determination result of step S403 is negative. In the above situation, the valid offset is “00001XXXX”, where the symbol X represents 1 or 0. Seen from the binary 0 at the MSB of the valid offset, step S403 is negative because the condition “the offset shift is smaller than the upper limit N of the offset shift” is false.

Taking an instance where a valid offset fetched in step S402 is “001001101” and the upper limit N of the offset shift is equal to 4, steps S403 and S404 are iterated twice. Only when the valid offset is adjusted to “1001101XX”, the determination result of step S403 is negative. In the above example, the offset shift is only 2 and has not yet reached the upper limit N of the offset shift. Seen from the binary 1 at the MSB of the valid offset, step S403 is negative because the condition “the valid offset is smaller than 256” is false.

The upper limit N of the offset shift limits the offset shift to not equal to or exceed the upper limit of the range shift, and it is impossible the offset shift be added up to be greater than 254 in the initialization process. Thus, decoding process is prevented from collapse caused by an excessively high offset shift during the offset initialization process.

As previously stated, as long as the offset shift does not exceed 254, the range shift may gradually catch up with the offset shift through step S202E, such that the comparison basis of the valid offset and the valid range may be kept consistent. After the range shift catches up with or exceeds the offset shift, as long as the decoding result is an LPS, the range shift and the offset shift are reset to zero and re-accumulated. One benefit of the above approach is that, adding the limitation of the upper limit N of the offset shift does not result in an undesirable effect on the accuracy of the decoding result, although time for the range shift to catch up with the offset shift is broken down into multiple shorter periods of time.

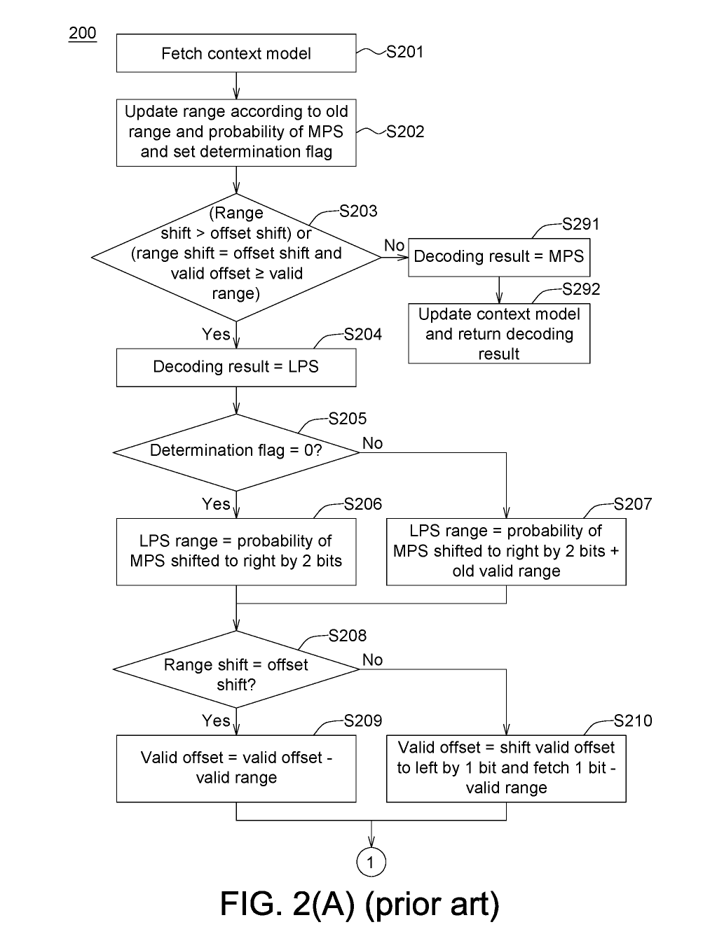

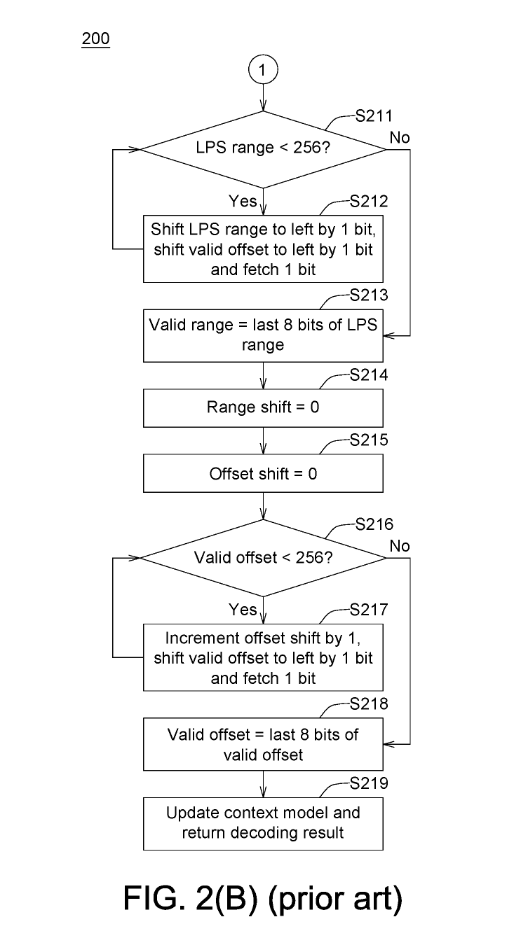

After the offset initialization process 400 ends, the main decoding process represented by FIG. 5(A) and FIG. 5(B) is continued. Comparing FIG. 5(A) and FIG. 2(A), steps S501 and S502 are known, and associated implementation details are omitted herein. Step S503 is divided into four following determination steps: 1) whether the range shift is greater than the offset shift; 2) whether the range shift is equal to the offset shift; 3) whether the last 8 bits of the valid offset are greater than or equal to the valid range; and 4) whether the preserved MSB (the 9^{th} bit)of the valid offset is binary 1. When the determination result of the determination step (1) is affirmative, or the determination results of all of the three determination steps (2) to (4) are affirmative, step S503 is affirmative, then it is confirmed that the symbol to be decoded is an LPS in step S504. In contrast, when the determination result of the determination step (1) is negative, and any of the determination results of the determination ste[ (2), (3) and (4) is negative, the determination result of step S503 is negative, and then it is confirmed that the symbol to be decoded is an MPS in step S523.

It should be noted that, the four determination steps in step S503 are not necessarily all performed. For example, if the determination step (1) is first performed and it is figured that result of the determination step (1) is affirmative, it may be confirmed that the determination result of step S503 is affirmative without having to continue performing the determinations (2) to (4). For another example, if it is figured that the determination result of the determination step (1) is negative, and any of the determination results of the determination steps (2) to (4) is negative, it may be confirmed that the determination result S503 is naturally negative without having to continue performing the other determinations.

Further, step S503 may also be realized by other equivalent combinations of the determinations (1), (2), (3) and (4). More specifically, when the conditions “the last 8 bits of the valid offset are greater than or equal to the valid range” and “the 9^{th} bit of the valid offset is binary 1” are simultaneously true, it is equivalent to “the valid offset is greater than or equal to the valid range added by 256”. By combining the determination steps (3) and (4), step S503 may be simplified. FIG. 5(A) shows simplified step S503. The scope of the present invention encompasses the equivalent combinations and variations of the above determinations, and is not limited to a predetermined combination.

Steps S505 to S515, are identical to steps S205 to S215 in FIG. 2 and shall be omitted herein. It should be noted that, steps S509 and step S510 require only the last 8 bits of the valid offset for operations. Therefore, step S521 is added before step S508 to reset the 9^{th} bit of the valid offset to binary 0 and to preserve the last 8 bits, hence maintaining the consistency of operation logics.

Subsequent steps S516 and S517 are an offset pre-fetching process, and have the same effect as steps S403 to S404 in FIG. 4. In step S516, “the offset shift is smaller than the upper limit N of the offset shift” is also considered when it is determined whether the offset pre-fetching process is to be terminated. This step can prevent the decoding process from collapse caused by an excessively high offset shift. When the determination result of step S516 is negative, the offset pre-fetching process is terminated, and the MSB (the 9^{th} bit) of the valid offset is preserved for the use of the next symbol determination process (step S503). That is to say, different from the decoding process 200, the decoding process 500 of the present invention does not include the step of discarding the 9^{th} bit of the valid offset (step S218) after the offset pre-fetching process. As shown in FIG. 5(B), when the determination result of step S516 is negative, step S522 of updating the context model and returning a decoding result is performed.

Also different from the decoding process 200, after the symbol to be decoded is determined as an LPS (step S523), step S522 of updating the context model and returning the decoding result is not performed immediately. As shown in FIG. 5(B), step S524 follows step S523 instead, which determines whether the range shift is equal to the upper limit N of the offset shift (step S524). When the determination result of step S524 is affirmative, steps S514 to S517 are performed. Only when the determination result of step S524 is negative, step S522 of updating the context model and returning the decoding result is performed.

One person skilled in the art can understand that, in FIG. 4, FIG. 5(A) and FIG. 5(B), the sequences of some steps or combinations of the determination logics may be exchanged without affecting the overall effect of the decoding method.

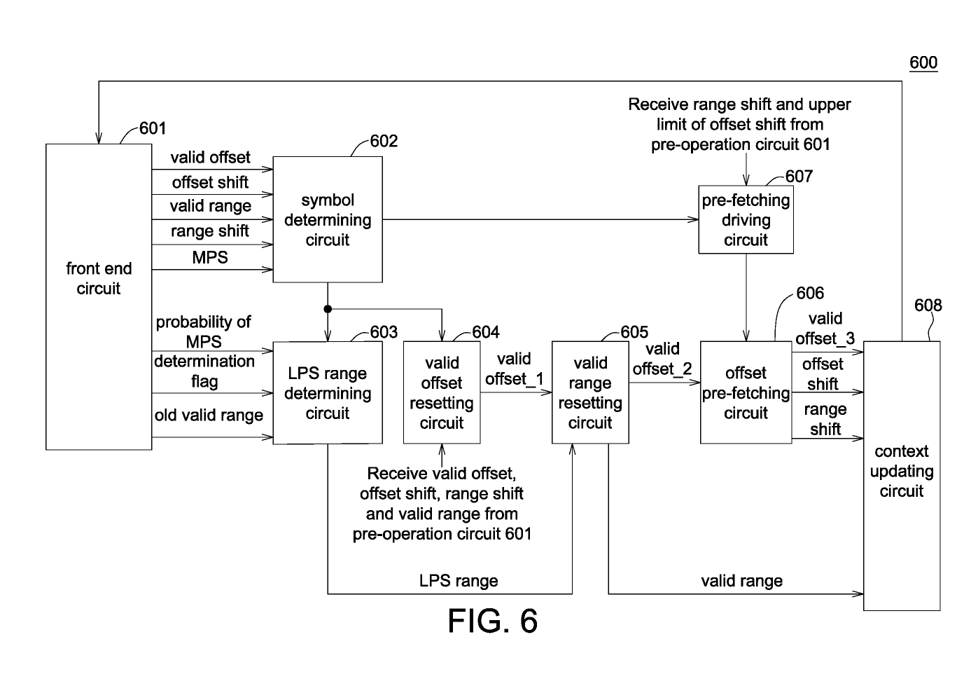

A decoding apparatus for decoding audio/video data in an AVS system is provided according to another embodiment of the present invention. FIG. 6 shows a functional block diagram of the decoding apparatus. A decoding apparatus 600 includes a front end circuit 601, a symbol determining circuit 602, a least probable symbol (LPS) range determining circuit 603, a valid offset resetting circuit 604, a valid range resetting circuit 605, an offset pre-fetching circuit 606, a pre-fetching driving circuit 607, and a context updating circuit 608.

The front end circuit 601 performs an offset initialization process (corresponding to steps S401 to S404), reads a context model (corresponding to step S501), updates a range according to a previous range and the probability of a most probable symbol (MPS) and sets a determination flag (corresponding to step S502). Further, the front end circuit 601 stores an upper limit N of an offset shift in advance. In practice, the front end circuit 601 may be provided with multiple registers for storing parameters or variables later to be used in the decoding process. In the offset initialization process, when the front end circuit 601 determines whether to terminate the offset pre-fetching process, it at the same time checks whether “the valid offset is smaller than 256” and “the offset shift is smaller than the upper limit N of the offset shift” (corresponding to step S403), so as to prevent a decoding process from collapse caused by an excessively high offset shift.

The symbol determining circuit 602 may learn whether the current MPS is binary 0 or binary 1 from the front end circuit 601. The symbol determining circuit 602 handles a symbol determination process (S503) according to the range offset, offset shift, valid offset and valid range provided by the front end circuit 601 to determine whether a symbol to be decoded in the audio/video data is an MPS or an LPS (S504 and S523). The valid offset that the front end circuit 601 provides to the symbol determining circuit 602 includes 9 bits, in which the most significant bit (MSB) (the 9^{th} bit) is not reset after the previous offset pre-fetching process (may be performed by the front end circuit 601 or the offset pre-fetching circuit 606) ends. Further, the 9^{th} bit is one reference for the symbol determining circuit 602 to perform the symbol determination process.

The LPS range determining circuit 603 and the valid offset resetting circuit 604 are both driven by an output signal of the symbol determining circuit 602 to operate. When the symbol determining circuit 602 determines that the current symbol to be decoded is an LPS, the LPS range determining circuit 603 determines a LPS range according to the probability of an MPS, the determination flag and an old valid range that the circuit 601 provides (S505 to S507). Further, when the symbol determining circuit 602 determines that the current code to be decoded is an LP\S, the valid offset resetting circuit 604 first sets the MSB of the valid offset to binary 0, and takes the last 8 bits of the valid offset as a new valid offset (S521). Next, the valid offset resetting circuit 604 again resets the valid offset according to the range shift, offset shift and valid range that the front end circuit 601 provides (corresponding to steps S508 to S510). In FIG. 6, the valid offset generated by the valid offset resetting circuit 604 is denoted as “valid offset_1”.

According to an LPS range that the LPS range determining circuit 603 provides, the valid range resetting circuit 605 resets the LPS range and the valid range (S511 to S513). The valid range resetting circuit 605 also correspondingly adjusts the valid offset (S512). In FIG. 6, the updated valid offset that the valid range resetting circuit 605 generates is denoted as “valid offset_2”. Next, the offset pre-fetching circuit 606 first resets the range shift and the offset shift to zero, and generates a new valid offset and a new offset shift according to the updated valid offset and the upper limit of the offset shift from the front end circuit 601 (S514 to S517). In FIG. 6, the valid offset generated by the offset pre-fetching circuit 606 is denoted as “valid offset_3”. When the offset pre-fetching circuit 606 determines whether to terminate the offset pre-fetching process, it also considers whether “the valid offset is smaller than 256” and “the offset shift is smaller than the upper limit N of the offset shift” (S516). As such, it can prevent the decoding process from collapse. Further, after the offset pre-fetching process is terminated, the offset pre-fetching circuit 606 preserves the MSB of the valid offset for the symbol determining circuit 602 to perform a next symbol determination process.

When the symbol determining circuit 602 determines that the symbol to be decoded is an MPS, the pre-fetching driving circuit 607 determines whether the current range shift is equal to the upper limit of the offset shift (S524). When the above determination result is affirmative, the pre-fetching driving circuit 607 also requests the offset pre-fetching circuit 606 to perform the above offset pre-fetching process. When the above determination result is negative, or the pre-fetching process has ended, the context updating circuit 608 updates a context model according to the valid range from the valid range resetting circuit 605, the valid offset, offset shift and range shift received from the offset pre-fetching circuit 606 (S522) for the reference of the pre-operation circuit 601.

In practice, the above circuits may be realized by various control and processing platforms, including fixed and programmable logic circuits, e.g., programmable logic gate arrays, application-specific integrated circuits (ASIC), microcontrollers, microprocessors, and digital signal processors (DSP). Further, the circuits may also be designed to perform multiple tasks through executing a processor instruction stored in a memory (not shown). One person skilled in the art can understand that, there are various other circuit configurations and elements capable of realizing the concept of the present invention without departing from the spirit of the present invention. Further, in practice, in the functional blocks, circuits that do not operate concurrently and have similar functions may be designed to shared hardware to reduce costs.

It should be noted that, operation variations in the description associated with the decoding process in FIG. 4, FIG. 5(A) and FIG. 5(B) are applicable to the decoding apparatus 600, and shall be omitted herein.

As previously stated, the upper limit N of the offset shift in steps S403, S516 and S524 may be any positive integer between 1 and 254. In one embodiment of the present invention, the upper limit N of the offset shift is set to 1. This setting would make the offset initialization process 400 in FIG. 4 simpler. As the offset shift is set to zero in step S401, the offset shift is equal to zero when step S403 is performed for the first time, such that the condition “the offset shift is smaller than the upper limit N (=1) of the offset shift” is naturally true. Thus, given that “the valid offset is smaller than 256” is trued, step S404 is performed, i.e., the offset shift is incremented by 1, the valid offset is shifted to the left by one bit, and another one bit is fetched. In the offset initialization process 400, after step S404 ends, step S403 is iterated. At this point, the condition “the offset shift is smaller than the upper limit N (=1) of the offset shift” is no longer true, and so the determination result of step S403 performed for the second time becomes negative.

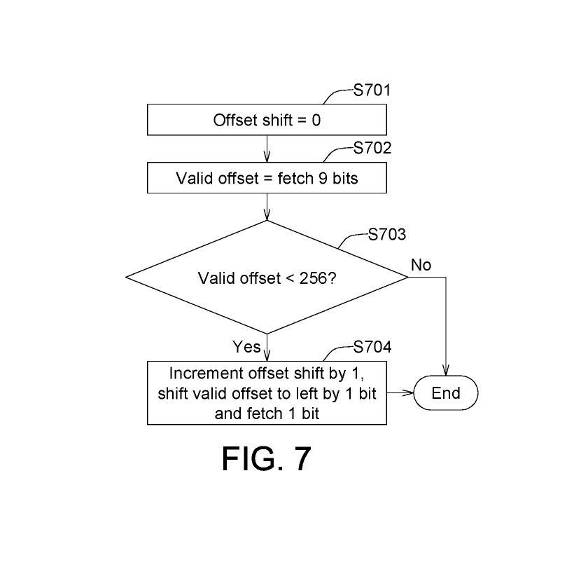

In conclusion, by setting the upper limit N of the offset shift to 1, the offset initialization process 400 may be simplified into a process shown in FIG. 7. Steps S701 and S702 are identical to steps S401 and S402. Step S703 only determines “whether the valid offset is smaller than 256”, which is more simplified than step S403. Step S704 is identical to step S404. In this simplified offset initialization process, step S704 is performed only once, and the offset pre-fetching process is subsequently terminated.

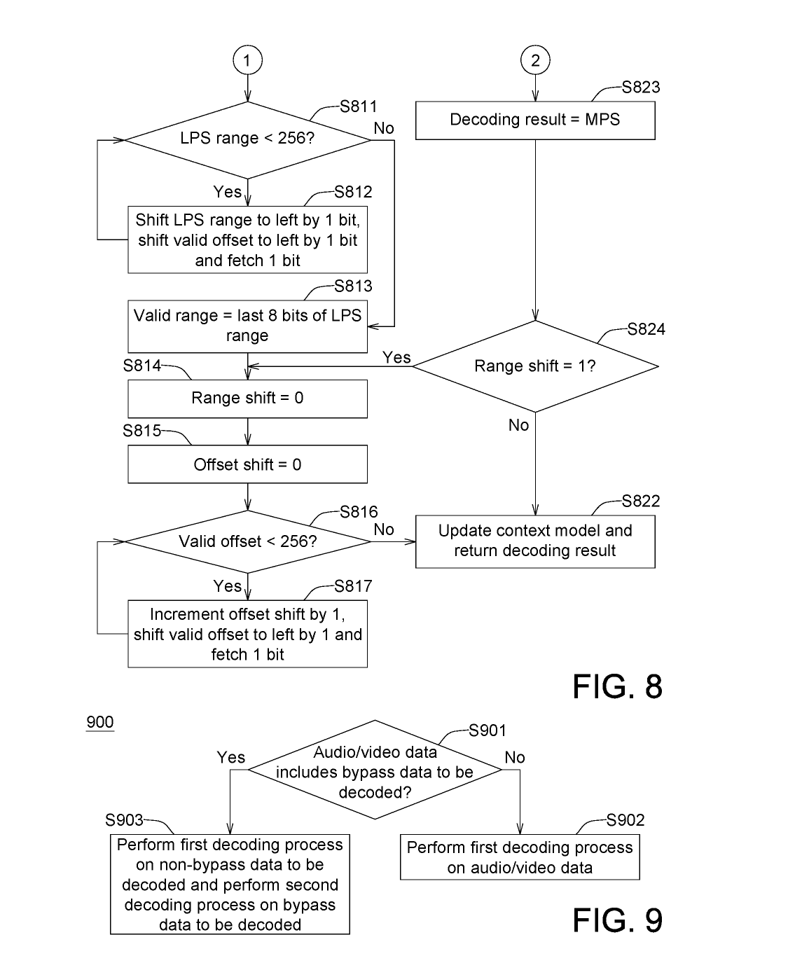

Similarly, the above concept may be applied to step S516 and S524 in the decoding process 500. FIG. 8 shows a rear half of a decoding process based on such simplification. Step S811 follows step S510 in FIG. 5(A), and step S823 follows step S503 in FIG. 5(A). Comparing FIG. 7 and FIG. 5(B), it is seen that, setting the upper limit N of the offset shift to 1 causes steps S816 and S824 to be simpler than the original steps S516 and S524.

The concept of setting the upper limit N of the offset shift to 1 may be applied to the decoding processes in FIG. 2(A) and FIG. 2(B). Thus, a decoding method for decoding audio/video data in an AVS system is further provided according to another embodiment of the present invention. According to the decoding method, a pre-fetching process includes steps of: a) determining whether a valid offset s lower than a predetermined value; and b) when the determination result of step (a) is affirmative, fetching a new least significant bit (LSB) for the valid offset. Wherein, the offset pre-fetching process is terminated after step (b) is performed once.

Further, the concept of setting the upper limit N of the offset shift to 1 may be applied to the hardware circuits in the decoding apparatus 600. The decoding apparatus includes an offset pre-fetching circuit (e.g., the offset pre-fetching circuit 606 in FIG. 6) that performs an offset pre-fetching process. The offset pre-fetching circuit includes a determining circuit and a fetching circuit. The determining circuit determines whether a valid offset is lower than a predetermined value (256). When the determination result is affirmative, the fetching circuit fetches a new LSB for the valid offset and immediately terminates the offset pre-fetching process.

In practice, an AVS transmitter may encodes absolute values and signs (+/−) separately, i.e., performing an encoding process on absolute values of multiple sets of data and then encoding respectively signs corresponding to the multiple sets of data. In most situations, the two signs (+/−) appear in a random fashion, which means that probabilities of both signs are close to 0.5. Thus, it is not efficient to perform compression on the signs of the data. Therefore, in AVS system, the AVS transmitter takes signs of data as bypass data. For example, different from non-bypass data, an MPS of bypass data is a constant value, and the probability of an MPS is also a constant value.

The property of the above bypass data is used to simplify the decoding process in an AVS receiver. FIG. 9 shows a flowchart of a decoding method for an AVS system according to an embodiment of the present invention. In step S901, it is determined whether audio/video data includes at least one set of bypass data. When the determination result of step S901 is negative, step S902 is performed to perform a first decoding process (e.g., a general decoding process in FIG. 4, FIG. 5(A) and FIG. 5(B)) on the audio/video data. When the determination result of step S901 is affirmative, step S903 is performed to perform the first decoding process on non-bypass data in the audio/video data and a second decoding process on the bypass to be decoded. Different from the first decoding process, the second decoding process may be designed especially for bypass data, and is simpler than the first decoding process. Compared to a conventional solution that performs a common decoding process on all audio/video data, the decoding process 900 is capable of reducing overall operation resources that the AVS system consumes.

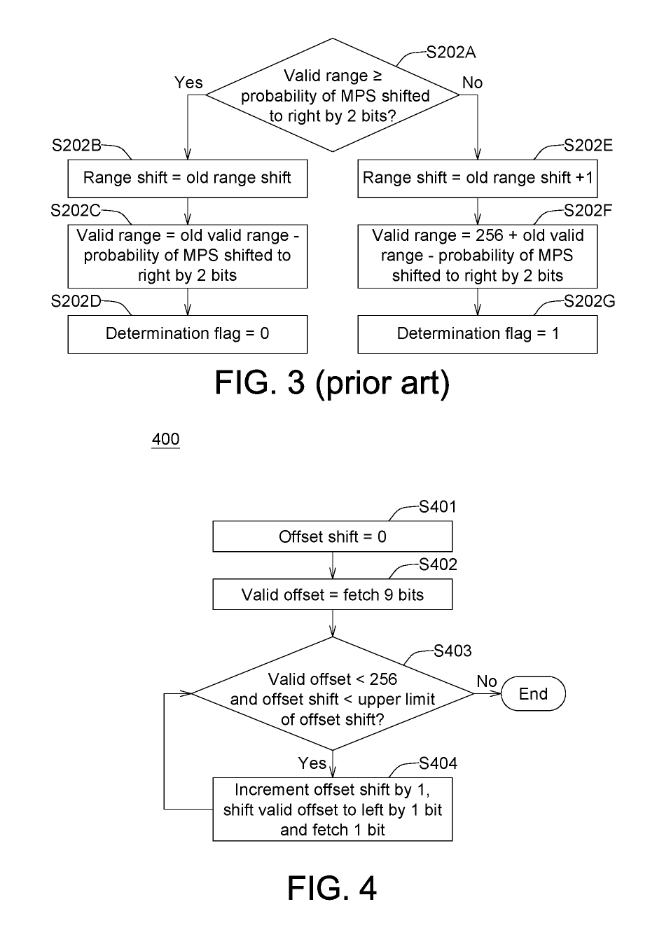

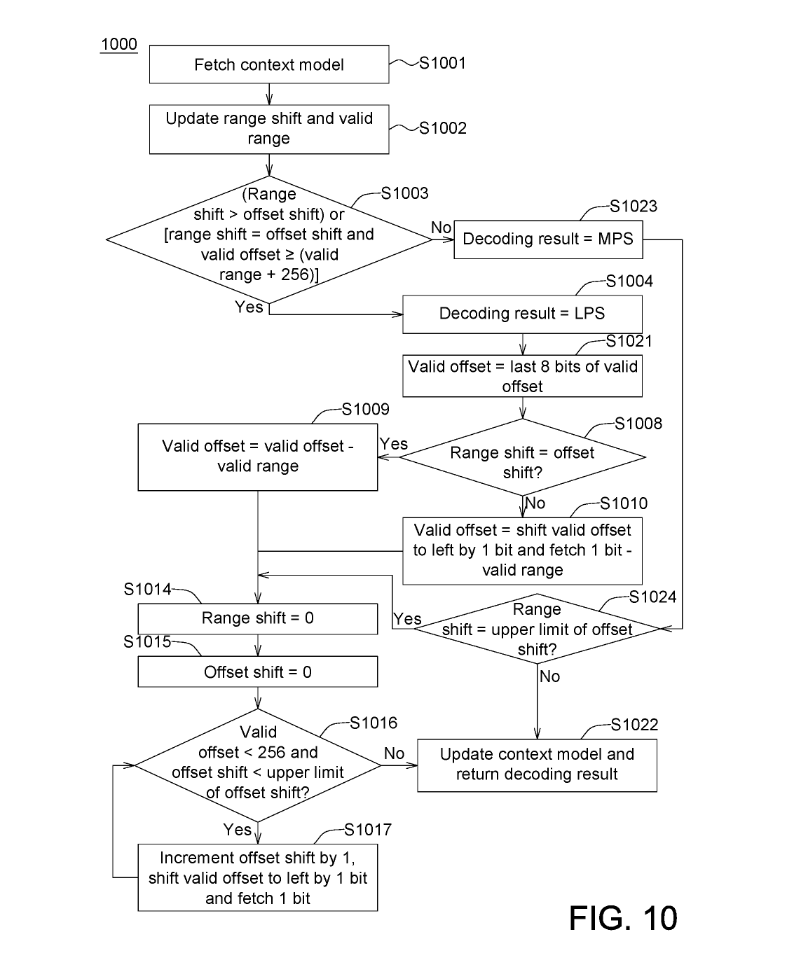

FIG. 10 shows a detailed implementation example of the second decoding process. Step S1001 is identical to step S501. As previously stated, the MPS probability of bypass data is a known constant value. The AVS specifications define that the MPS probability is to be set to correspond to a value 1024. Thus, a result of shifting the MPS probability to the right by two bits (=256) inevitably becomes greater than the possible maximum (=255) of the valid range. Based on such characteristic, certain determination steps may be omitted. For example, the determination result of step S202A in FIG. 3 is naturally negative, in a way that the determination flag is also naturally 1. In the above situation, the existence of the determination flag has no substantial significance. Thus, step S1002 may include only steps S202E and S202F in FIG. 3.

The subsequent steps S1003, S1004, S1021 and S1008 to S1010 are respectively identical to steps S503, S504, S521 and S508 to S510. In continuation of the above, the determination flag is 1, meaning that the determination result of step S505 is naturally negative, such that the LPS range is set as the MPS probability shifted to the right by two bits (=256) added by the old valid offset in step S507. Due on such smaller LPS range generated accordingly, the determination result of step S511 is naturally negative. Based on the above logic deduction, steps S505 to S507 and steps S511 to S513 may be omitted in a decoding process 1000. The subsequent steps S1014 to S1017 and steps S1022 to S1024 are respectively identical to steps S514 to S517 and steps S522 to S524, and shall be omitted herein. As opposed to the decoding process, as in FIG. 4, FIG. 5(A) and FIG. 5(B), which is regarded as the first decoding process, the second decoding process shown in FIG. 10 is apparently much simpler.

For an AVS receiver, bypass data usually arrives subsequently to non-bypass data. For example, after receiving absolute values of multiple successive sets of data, the AVS receiver may expect to receive a series of positive/negative signs respectively corresponding to these multiple sets of data. More specifically, after receiving absolute values of M successive sets of data (where M is an integer greater than 1), the AVS receiver may expect to receive bypass data corresponding to the M successive positive/negative signs. It should be noted that, when audio/video data includes multiple successive sets of bypass data, the second decoding process may be further simplified, with associated details given below.

Assume that the pre-fetching process earlier on already fetched P bits of the valid offset (where P is an integer) before the M sets of bypass data is decoded, the offset shift is equal to P, which is information originally known to the AVS receiver. According to an embodiment of the present invention, the number of LPSs corresponding to the M sets of bypass data can be promptly determined according to the relationship between sizes of the value P and the value M.

A situation where M is smaller than P is first discussed. Because M is greater than 1 and it is known that M is smaller than P, P is naturally greater than 2. As previously stated, the range shift is reset to zero in the offset pre-fetching process. Next, when starting to decode the M successive sets of bypass data, the range shift is incremented by 1 in step S1002. As the current range shift (=1) is smaller than the offset shift P (>2), the determination of step S1003 performed for the first time is naturally negative such that the first set of decoding result is an MPS. By designing the upper limit N of the offset shift to a higher value (e.g., a possible maximum value greater than P), the determination result of the subsequent step S1024 is naturally negative. In the above situation, steps S1001, S1002, S1003, S1023, S1024 and S1022 are iterated M times. It is may then be deduced that, when M is smaller than P, the decoding results of the M successive sets of bypass data are naturally M MPSs. Further, after the M times of iterations, the last range shift is gradually increased to be equal to the value M.

A situation where M is greater than or equal to P is next discussed. Based on the determination rule of step S1003, the MSB of the valid offset is binary 1 after the offset pre-fetching process, and the determination result of step S1003 performed for the first (P−1) times is all negative and is only affirmative for the P^{th} time. It is deduced that, when M is greater than or equal to P, and the MSB of the valid offset is binary 1, the decoding results of the first P sets among the M successive sets of bypass data are naturally (P−1) successive MPSs and one LPS. Further, the final range offset is gradually increased to be equal to the value P.

Similarly based on the determination rule in step S1003, when M is greater than or equal to P, the determination result of step S1003 is negative for the first P times when the MSB of the valid offset is binary 0. It is deduced that, when M is greater than or equal to P and the MSB of the valid offset is binary 0, the decoding results of the first P sets among the M successive sets of bypass data are naturally P MPSs. Further, the final range offset is gradually increased to be equal to the value (P−1).

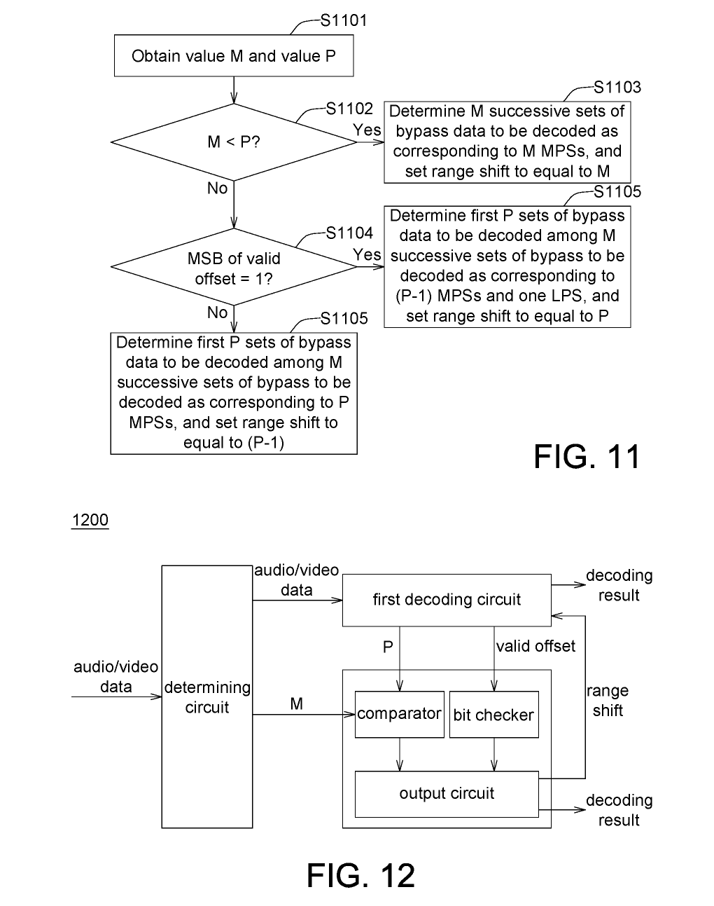

In conclusion, according to the relationship between the value P and the value M, the second decoding process may be simplified into a process in FIG. 11. In step S1101, the value M and the value P are obtained. In step S1102, it is determined whether “M is smaller than P” is true. When the determination result of step S1102 is affirmative, step S1103 is performed, where it is directly determined that, the decoding results of the M successively sets of bypass data are M MPSs, and the range shift is set to equal to the value M. When the determination result of step S1102 is negative, step S1104 is performed to continue determining whether “the MSB of the valid offset is binary 1” is true. When the determination result of step S1104 is affirmative, step S1105 is performed, where it is directly determined that, the decoding results of the first P sets among the M successive sets of bypass data are (P−1) successive MPSs and one LPS, and the range shift is set to be equal to the value P. When the determination result of step S1104 is negative, step S1106 is performed, where it is directly determined that, the decoding results of the first P sets among the M successive sets of bypass data are P MPSs, and the range shift is set to be equal to the value (P−1). Compared to the second decoding process in FIG. 10, the second decoding process in FIG. 10 is apparently much more simplified.

The above concept of simplifying a decoding process based on the characteristic of bypass data may also be applied to a hardware device. FIG. 12 shows a functional block diagram of a decoding apparatus for decoding audio/video data in an AVS system according to an embodiment of the present invention. A decoding apparatus 1200 includes a determining circuit 1201, a first decoding circuit 1202 and a second decoding circuit 1203. The determining circuit 1201 determines whether the audio/video data includes at least one set of bypass data. When the determination result of the determining circuit 1201 is negative, the first decoding circuit 1202 performs a first decoding process on the audio/video data. When the determining circuit 1201 is affirmative, the first decoding circuit 1202 performs the first decoding process on non-bypass data in the audio/video data, and the second decoding circuit 1203 performs a second decoding process that is different from the first decoding process on the at least one set of bypass data.

In practice, an internal circuit of the first decoding circuit 1202 may be the foregoing decoding apparatus 600, and the first decoding process may be the decoding process in FIG. 4, FIG. 5(A) and FIG. 5(B), details of which being omitted herein. In the embodiment in FIG. 12, a second decoding circuit 1203 includes a comparator 1203A, a bit checker 1203B and an output circuit 1203C. The comparator 1203A compares the value M obtained from the determining circuit 1201 and the value P obtained from the first decoding circuit 1202. The bit checker 1203B checks whether the MSB of the valid offset obtained by the first decoding circuit 1202 is binary 1 or binary 0.

When the comparator 1203A determines that the value M is smaller than the value P, the output circuit 1203C outputs M MPSs as the decoding results, and provides the setting of the range shift equal to the number M to the first decoding circuit 1202. When the comparator 1203A determines that M is greater than or equal to P, and the bit checker 1203B determines that the MSB of the valid offset is binary 1, the output circuit 1203C outputs (P−1) MPSs and one LPS as the decoding results, and provides the setting of the range shift equal to the value P to the first decoding circuit 1202. When the comparator 1203A determines that M is greater than or equal to P and the bit checker 1203B determines that the MSB of the valid offset is binary 0, the output circuit 1203C outputs P MPSs as the decoding results, and provides the setting of the range shift equal to the value (P−1) to the first decoding circuit 1202.

Variations in the description associated with the decoding processes in FIG. 9 to FIG. 11 are applicable to the decoding apparatus 1200, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A decoding method, for decoding audio/video data in an Audio Video coding Standard (AVS) system, comprising:
a) determining whether to terminate an offset pre-fetching process according to whether an offset shift reaches an upper limit of the offset shift, wherein the upper limit of the offset shift is greater than zero and smaller than an upper limit of a range shift;
b) preserving a most significant bit (MSB) of a valid offset after the offset pre-fetching process is terminated; and
c) determining a symbol to be decoded in the audio/video data as one of a most probable symbol (MPS) and a least probable symbol (LPS) according to the preserved MSB of the valid offset.

2. The decoding method according to claim 1, wherein step (c) comprises:
c1) determining whether the range shift is equal to the offset shift;
c2) determining whether the valid offset is greater than or equal to a valid range;
c3) determining whether the preserved MSB of the valid offset is binary 1; and
c4) when determination results of steps (c1), (c2) and (c3) are all affirmative, determining the symbol to be decoded as the LPS.

3. The decoding method according to claim 1, wherein step (c) comprises:
c5) determining whether the range shift is equal to the offset shift;
c6) determining whether the valid offset, with the preserved MSB, is greater than or equal to a sum of a valid range and a predetermined value; and
c7) when determination results of step (c5) and (c6) are both affirmative, determining the symbol to be decoded as the LPS.

4. The decoding method according to claim 1, further comprising:
when the symbol to be decoded is determined as the MPS in step (c), and the range shift is equal to the upper limit of the offset shift, performing the offset pre-fetching process.

5. The decoding method according to claim 1, wherein the offset pre-fetching process comprises:
when the valid offset is lower than a predetermined value, fetching a new least significant bit (LSB) for the valid offset and terminating the offset pre-fetching process.

6. A decoding apparatus, for decoding audio/video data in an Audio Video coding Standard (AVS) system, comprising:
an offset pre-fetching circuit, performing an offset pre-fetching process, determining whether to terminate the offset pre-fetching process according to whether an offset shift reaches an upper limit of the offset shift, and preserving a most significant bit (MSB) of a valid offset after the offset pre-fetching process is terminated, wherein the upper limit of the offset shift is greater than zero and smaller than an upper limit of a range shift; and
a symbol determining circuit, determining a symbol to be decoded in the audio/video data as one of a most probable symbol (MPS) and a least probable symbol (LPS) according to the preserved MSB of the valid offset.

7. The decoding apparatus according to claim 6, wherein the symbol determining circuit comprises:
a first determining circuit, determining whether the range shift is equal to the offset shift;
a second determining circuit, determining whether the valid offset is greater than or equal to a valid range;
a third determining circuit, determining whether the preserved MSB of the valid offset is binary 1; and
a fourth determining circuit, when determination results of the first determining circuit, the second determining circuit and the third determining circuit are all affirmative, determining the symbol to be decoded as the LPS.

8. The decoding apparatus according to claim 6, wherein the symbol determining circuit comprises:
a first determining circuit, determining whether the range shift is equal to the offset shift;
a second determining circuit, determining whether the valid offset with the preserved MSB is greater than or equal to a sum of a valid range and a predetermined value; and
a third determining circuit, when determination result of the first determining circuit and the second determining circuit are both affirmative, determining the symbol to be decoded as the LPS.

9. The decoding apparatus according to claim 6, further comprising:
an offset driving circuit, determining whether the range shift is equal to the upper limit of the offset shift when the symbol determining circuit determines the symbol to be decoded as the MPS, and requesting the offset pre-fetching circuit to perform the offset pre-fetching process when the range shift is equal to the upper limit of the offset shift.

10. The decoding apparatus according to claim 6, wherein the offset pre-fetching circuit comprises:
a determining circuit, determining whether the valid offset is lower than a predetermined value; and
a fetching circuit, fetching a new least significant bit (LSB) for the valid offset when a determination result of the determining circuit is affirmative, and terminating the offset pre-fetching process.

11. A decoding method, for decoding audio/video data in an Audio Video coding Standard (AVS) system, comprising:
a) determining whether the audio/video data comprises at least one set of bypass data
b) performing a first decoding process on the audio/video data when a determination result of step (a) is negative; and
c) performing a second decoding process different from the first decoding process on the at least one set of bypass data when the determination result of step (a) is affirmative.

12. The decoding method according to claim 11, wherein when the audio/video data comprises a plurality of successive sets of bypass data, the second decoding process comprises:
determining the number of most probable symbols (MPSs) corresponding to the plurality of successive sets of bypass data according to an offset shift and the number of the plurality of successive sets of bypass data.

13. The decoding method according to claim 12, wherein the audio/video data comprises M successive sets of bypass data, M is an integer greater than 1, the offset shift is equal to P, P is a positive integer, and the second decoding process comprises:
when M is smaller than P, determining that the M successive sets of bypass data correspond to M number of MPSs.

14. The decoding method according to claim 12, wherein the audio/video data comprises M successive sets of bypass data, M is a positive integer greater than 1, the offset shift is equal to P, P is a positive integer, and the second decoding process comprises:
when M is greater than or equal to P, and a most significant bit (MSB) of a valid offset is binary 1, determining that the first P sets among M successive sets of bypass data are corresponding to (P−1) MPSs and one least probable symbol (LPS), respectively.

15. The decoding method according to claim 12, wherein the audio/video data comprises M successive sets of bypass data, M is a positive integer greater than 1, the offset shift is equal to P, P is a positive integer, and the second decoding process comprises:
when M is greater than or equal to P, and a MSB of a valid offset is binary 0, determining that the first P sets among M successive sets of bypass data are respectively corresponding to P MPSs.
